(19) United States
(12) Patent Application Publication
(10) Pub. No.: US 2008/0206730 A1
(43) Pub. Date: Aug. 28, 2008

(54) System and method of providing video-based training over a communications network

(76) Inventors: Hormuzd Kali Umrigar, Mumbai (IN); Shailesh H. Mehta, Mumbai (IN)

Correspondence Address: KNOBBE MARTENS OLSON & BEAR LLP, 2040 MAIN STREET, FOURTEENTH FLOOR, IRVINE, CA, 92614, US

(21) Appl. No.: 11/710,331

(22) Filed: Feb. 23, 2007

(51) Int. Cl. G09B 7/04

(52) U.S. Cl. 434/322

(57) ABSTRACT

Systems and methods of providing video-based training to a computing device in a computer network are provided. Training data comprising a plurality of video segments and a plurality of questions related to the video segments is sent over a computer network. The video segments are delivered in a video stream to the computing device. The video stream is paused, and questions relevant to the previously displayed segment of the training data are displayed to a user. The user response is received and if the received data does not include a correct response, the video stream is resent from the beginning of the segment of the video training data displayed prior to pausing the video stream.

### BACKGROUND OF THE INVENTION

1. Field of the Invention

This application relates to network-based training. In particular, this application relates to a system and method of providing video-based training over a communications network.

2. Description of the Related Technology

In the past several years, in an attempt to control the costs of training groups of people in disparate locations, a new type of educational protocol has developed which is known as “distance learning.” As the Internet has become an increasingly ubiquitous part of our lives, distance learning models have begun to utilize Internet-based technologies to deliver learning content to students. As broadband capability has increased, it has become more and more feasible to deliver rich multimedia content in the form of graphics and video to students via the Internet, and some current systems do just that. However, these current network-based systems suffer from various inefficiencies and drawbacks. For example, current systems often require specialized software to be installed on the student's computer, a requirement that tends to introduce unwanted complexity into the process. Content creation with existing systems also tends to require specialized hardware and/or software, and it is difficult and costly for non-technical educators to develop courses which are rich in multimedia content. Therefore, it would be an improvement and an advancement to provide a network-enabled system that alleviates and/or eliminates the shortcomings described above.

### SUMMARY OF CERTAIN INVENTIVE ASPECTS

The system, method, and devices of the present invention each have several aspects, no single one of which is solely responsible for its desirable attributes. Without limiting the scope of this invention, several of its features will now be discussed briefly.

In one embodiment, a method of providing video-based training to a computing device in a computer network is provided. The method includes sending training data comprising a plurality of video segments and a plurality of questions related to the video segments over the computer network. The video segments are delivered in a video stream to the computing device. The method further includes pausing the video stream and sending a selected one of the questions relevant to a first video segment of the training data displayed prior to pausing the video stream. The method further includes receiving data indicative of a response to the question and determining if the received data includes a correct response. If the received data does not include a correct response, the video stream is resent from the beginning of the segment of the video training data displayed prior to pausing the video stream and replaying the segment of the video training data.

In another embodiment, a system for providing video-based online training to a student is provided. The system includes a video serving module configured to access stored prerecorded video data having educational content, the prerecorded video data having a plurality of video segments, the video serving module being further configured to send the prerecorded video data to a computing device causing the computing device to play one of the segments of the video content in a video portion of a video module. The system also includes a monitoring module configured to access a plurality of questions, each of the questions being related to one or more of the video segments, the monitoring module being further configured to pause the sending of video content at the end of one or more of the segments, and to send a question related to the video content requiring a response. If the response is not a correct response to the displayed question, the video serving module returns to the beginning of the segment and resends the video content in the segment to the computing device.

In yet another embodiment, a computer-readable medium for generating a user interface for a browser software in a computer is provided. The computer-readable medium includes computer-executable instructions which, when executed send data to the browser causing it to create a user interface in a browser window. The user interface comprises a video module configured to display streaming video in a video segment. The user interface also includes a question module configured to display questions related to the video segment. The video module further comprises a playerless video element configured to receive the video data through a socket connection.

### BRIEF DESCRIPTION OF THE DRAWINGS

In this description, reference is made to the drawings wherein like parts are designated with like numerals throughout.

FIG. 1 is a block diagram depicting various components of the system for providing video-based training over a communications network.

FIG. 2 is a block diagram providing a more detailed view of the video-based training system from FIG. 1.

FIG. 3 is a block diagram providing a more detailed view of the data storage of the video-based training server shown in FIGS. 1 and 2.

FIG. 4 is a more detailed block diagram of the course data from FIG. 3.

FIG. 5 is a more detailed block diagram of the user data from FIG. 3.

FIG. 6 is a more detailed block diagram of the student data from FIG. 3.

FIG. 7 is a more detailed block diagram of the pedagogical coordination data from FIG. 3.

FIGS. 8A-8C provide illustrations of a user interface having three inter-related viewing modules according to one or more embodiments.

FIG. 9 is a flowchart illustrating a method of creating video-based training.

FIG. 10 is a flowchart illustrating a method of providing video-based training to a student in accordance with one or more embodiments.

### DETAILED DESCRIPTION OF CERTAIN INVENTIVE EMBODIMENTS

Various embodiments of the invention provide for systems and methods which allow for the easy generation of electronic learning content and delivery of that generated content to students in such a way that provides a multi-sensory learning experience. The delivery mechanism makes use of a content delivery environment which allows students to access learning content without any customization or installation of software on the student computing device. In certain embodiments, learning content may be distributed within a conventional web browser which divides its interface into three inter-related viewing modules: a streaming video module which presents streaming video of a live course lecture, a slide display module which displays presentation content related to the course lecture, and a question and answer module which periodically tests the students knowledge of topics covered in the streaming video. This delivery environment provides for a multi-sensory learning enforcement mechanism which monitors the progress of students and requires their understanding and retention of the viewed content before allowing them to proceed further into the current lesson. These and other features are described with reference to the figures below.

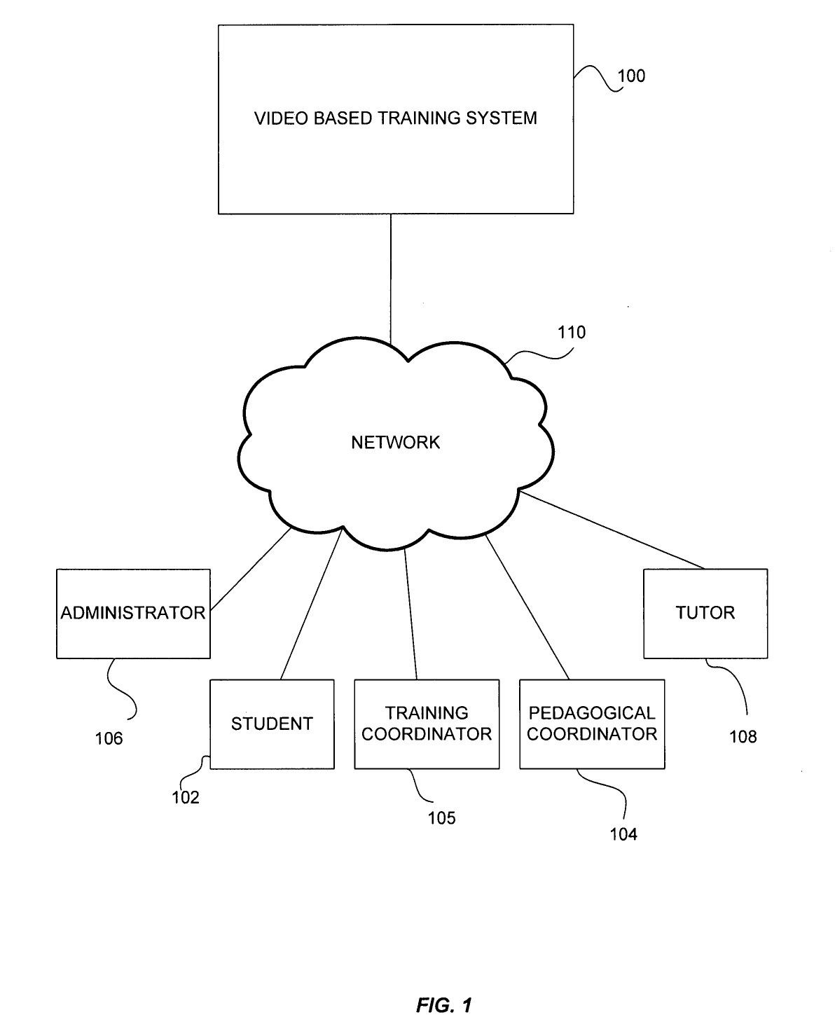

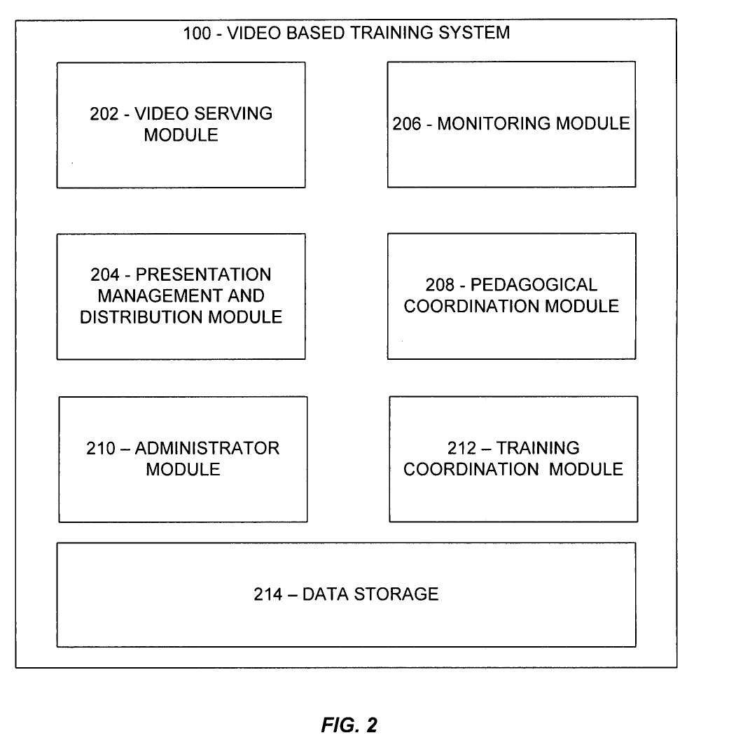

Various embodiments of the present invention may be implemented within a computer network environment. FIG. 1 provides an illustration of a suitable environment for implementation of the systems and methods provided herein. The network environment includes a network 110. In the embodiments described herein, the network 110 is a wide area network such as the Internet, for example. However, one of skill in the art will readily appreciate that the network 110 may be any of a number of different types of networks including a local area network, a wireless network, or some other type of network known in the art. Connected to the network 110 is a video based training system (“VBT system”) 100. The VBT system 100 may be an application or group of applications running on one or more computing devices. In the embodiments described herein, the VBT system is implemented as a web application service which utilizes a video content server and a data management server to provide content for the web application services. A skilled artisan will recognize however that there are numerous hardware and software configurations which may be used to implement the VBT system 100 which is described in further detail with reference to FIGS. 2-8 below.

Also connecting to the network are one or more students 102. As used herein, a student is a person or entity that accesses the VBT system 100 via the network 110 for the purpose of receiving training or education. Training and education as used herein refer to training and education provided in the corporate sector as well as both formal and informal education provided in the context of a more traditional learning environment such as a primary school, a secondary school, a college, a university, or a professional school. Also accessing the network 110 is a pedagogical coordinator 104. As will be further described below, a pedagogical coordinator 104 typically participates in and supervises the creation and distribution of video-based training content from the VBT system 100. A training coordinator 105 may also access the VBT system 100 via the network 110. The training coordinator 105 is a person in an organization using the VBT system 100 that communicates with the students 102 via the network 110 and facilitates and manages the student use of the VBT system 100. The network 110 may also be accessed by one or more system administrators 106. The system administrator 106 is a technical manager who typically manages the technical features of the VBT system 100 much as a network administrator does in a conventional network environment. One or more tutors 108 may also access the VBT system via the network 110. A tutor 108 is typically an instructor with some expertise in a portion of the educational subject matter distributed from the VBT system 100 who interacts with one or more students 102 to help them better understand the subject matter. In some embodiments, the tutor 108 may be assigned a task of adjusting the level of training for students based on their performance using the system. The pedagogical coordinator 104 may supervise the tutor 108 to ensure adequate training and supervision of the students 102. The students 102, pedagogical coordinator 104, training coordinator 105, administrator 106, and tutor 108 typically access the VBT system 100 using a computing device such as a personal computer, a notebook computer, a handheld computing device, a cell phone, or some other network enabled device.

As noted previously, the VBT system 100 provides a course delivery environment by which student are able to access courses online and to receive training via the network 110. The use of the VBT system 100 as an application service provides the ability to define many courses on behalf of many organizations utilizing a single VBT system 100. Thus, the students 102, pedagogical coordinators 104, training coordinators 105, and tutors 108 may be grouped by organization so that the VBT system 100 may be configured provide selective access to content stored in the system 100 utilizing access permissions based on the organization and role of the user.

FIG. 2 provides a more detailed diagram of the VBT system 100 from FIG. 1. The VBT system 100 includes a video serving module 202. The video serving module 202 typically includes server software that is configured to deliver streaming video content over the network 110. In some embodiments, the server software may be commercial video streaming software such as Quicktime, RealVideo, Windows® Media server. Alternatively, the video serving software may be a customized solution developed solely for the VBT system 100. The video serving module 202 may distribute video content in various formats. In some embodiments, the distributed video may include a may be a well-known data format such as MPEG, AVI, Quicktime, RealVideo, or some other video format.

The video based training system 100 may also include a presentation management module 204. The presentation management module 204 is typically configured to store presentation data that is related to the video data and send it to the student workstation 102 for display with video distributed by the video serving module 202. In one embodiment, the slide management module stores presentation data in the form of a PowerPoint slide show, or some comparable slide show file, and converts it into a Flash object which is embedded in the browser page sent by the VBT system 100 to the student 102.

The VBT system 100 may further include a monitoring module 206. The monitoring module 206 is a software component that monitors the progress of a student 102 as a student utilizes the VBT system 100. In some embodiments, the monitoring module 206 is configured to send questions to the student 102 at predetermined intervals. The questions may be retrieved from a question bank and may be related to a segment of video content recently displayed to the student by the video serving module 202. The monitoring module 206 is typically configured to work in conjunction with the video serving module 202 and presentation management module 204. Each of the video serving module 202, the presentation management module 204, and the monitoring module 206 will discussed in additional detail below.

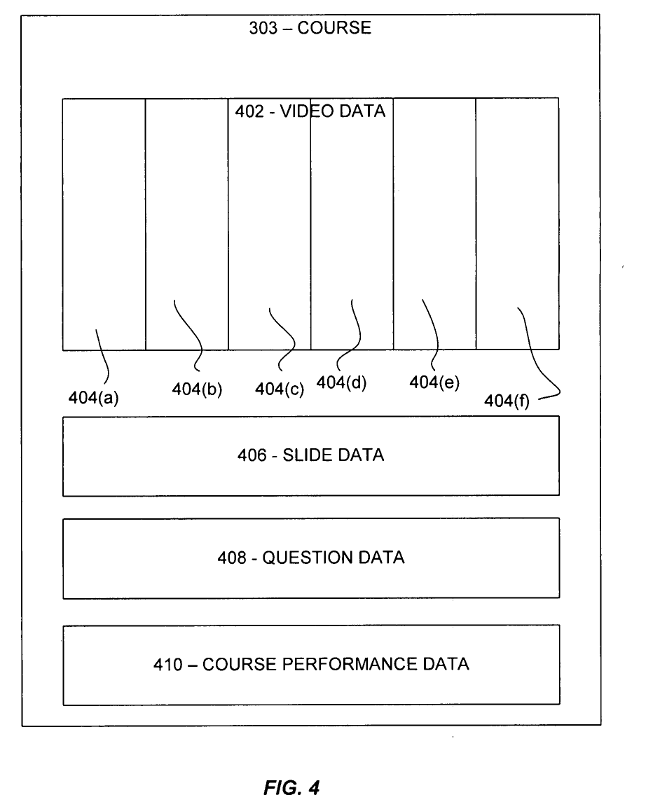

The VBT system 100 may also include a pedagogical coordination module 208. The pedagogical coordination module 208 is a software module which allows the pedagogical coordinator to develop and manage online course data by creating and uploading course content to the VBT system 100 via a pedagogical administrative interface. In some embodiments, the pedagogical coordination module provides a user interface that allows for the creation and modification of online courses by providing a video learning object creation/modification interface which is discussed in further detail below in connection with FIG. 4.

The VBT system 100 also typically includes an administrator module 210 which allows the administrator 106 full administrative access to the VBT system 100. The administrator module 210 includes management software that allows the administrator 106 to manage the general operation of the VBT including user account management, password management, user interface management for customers, and installation of user licenses on the system. In addition to the administrator module 210, the VBT system also includes a training coordination module 212. The training coordination module 212 includes software that is accessed by the training coordinator 105 and allows the training coordinator 105 to perform its assigned functions. In some embodiments, these assigned functions may overlap with those given to the administrator 106, and as a result, the user interface provided by the administrator module 210 may share similarity with that of the training coordination module 212. In addition, the training coordination module 212 may also include a e-mail distribution interface which allows the training coordinator 105 to send communications to students 102 and other participants in the VBT system to notify them of changes the course deadlines or other information. The training coordination module 212 also provides the training coordinator 105 access to data which allows the training coordinator to monitor and analyze the performance of students 102 as they participate in courses via the VBT system 100.

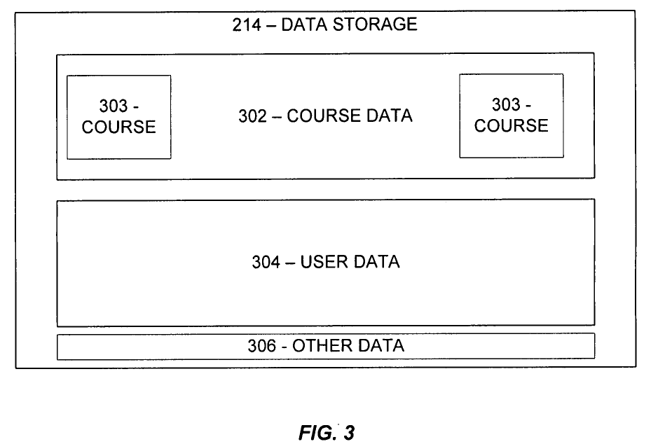

The VBT system 100 also includes data storage 214 for storing data related to or generated by the system. Because the VBT system 100 stores various types of media, the data storage may be located on one or more separate computing devices that communicate with the other system modules via the network 110 or some other type of connection. Such a configuration may be useful to improve system performance. The data storage 214 may include various types of data as shown in FIG. 3. For example, the data storage 214 may include course data 302 which includes one or more courses 303 defined and stored in the VBT system 100. The data storage 214 may also include user data 304 which includes data that relates to users who access the system. Data storage 214 may also include other data 306 such as access logs, graphics, application data, or other types of data.

As discussed above, the VBT system 100 is capable of maintaining a large number of courses and lessons which may be associated with certain groups of users (such as those associated with a particular organization, for example). FIG. 4 provides a more detailed view of the data which may be included with each of the courses 303 defined in the VBT system 100. Each course 303 may include video data 402. The video data 402 may be any of a number of data formats including MPEG, AVI, Quicktime, RealVideo, or some other type of video encoded data. The video data 402 will generally include one or more video-taped live lessons related to the course material. Each of the lessons stored as video data 402 may be divided into one or more video segments 404. In the example provided, the video data 402 for a course lesson is divided into six segments, 404(a) through 404(f). As will discussed in further detail below, the video segments 404 are generally divided into intervals which are amenable to testing on topics covered in the material. For example, the intervals may be based on chapters covered in a textbook associated with the course 303, or they may be defined in terms of specific concepts covered during the lecture. The VBT system 100 generally allows the pedagogical coordinator 104 for each specific course 303 to determine how to divide the video data 402 into segments 404. As will be discussed in further detail below, the video data 402 is distributed to users by streaming it over the network using the video serving module 202.

Each course 303 also includes presentation data 406. The presentation data 406 for a course 303 generally takes the form of electronic slides (such as Powerpoint slides, for example) which are associated with the topics covered in the video data 402. The presentation data 406 is typically handled by the presentation management module 204 which may be configured to associate certain slides with specific segments 404 of the video data 402. These slides may be prepared and associated with the video data 402 by the pedagogical coordinator 104 via the pedagogical coordination module user interface.

Each course 303 may also include question data 408. The question data 408 may take the form of a question bank which includes a series of questions that are associated with specific video segments 404. The question data 408 may further include answer choices to the questions. As will be discussed in detail below, at the end of each video segment, the VBT system 100 may present to a student 102 accessing the course 303 one or more questions from the question bank. The student will only be permitted to continue to the next video segment 404 if they provide a correct response to the question. Otherwise, the student will be returned to the beginning of the segment 404 to review the material again.

Each course 303 may also have performance data 410 associated with it. The course performance data 410 is data maintained by the VBT system 100 which tracks the performance of students in a particular course 303. The course performance data 410 may include data related to student performance on questions related to certain video segments 404. For example, the VBT system 100 may be configured to track the number of correct and incorrect responses to questions that are presented with each video segment 404. Collecting this performance data 410 allows the pedagogical coordinator 104 (or some other interested party) to analyze the course content to identify trends and statistical anomalies in the student performance. For example, the performance data 410 may show that students give incorrect answers to a large number of questions that are presented following a particular video segments (such as 404(d), for example). This anomaly may be an indication that either the questions are too difficult or that the subject matter in the video segment is not well-understood and may need to be clarified. Once of the advantages to the VBT system 100 is that the video-based segments are easily modified. The pedagogical coordinator may simply have the instructor re-record the video segment 404 and then upload the modified segment to the VBT system 100.

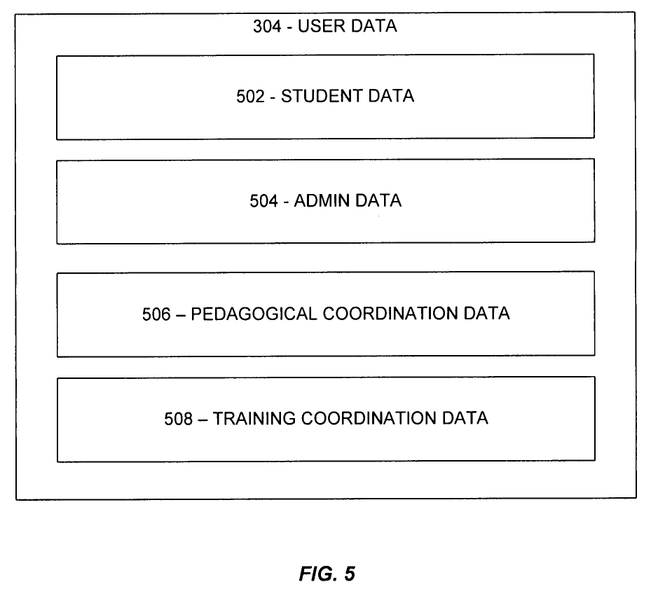

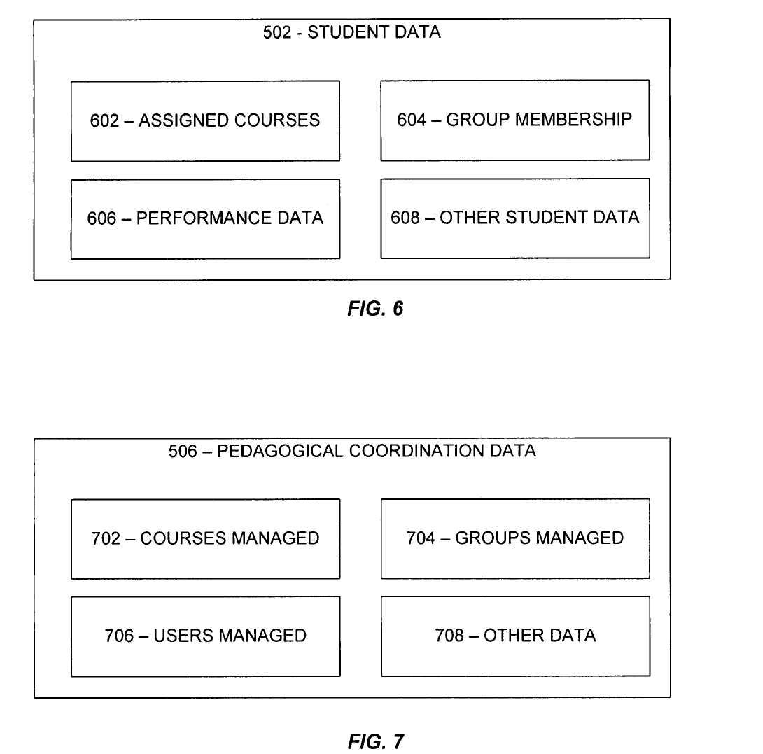

As noted above in connection with FIG. 3, the data storage 214 may also include user data 304. The user data 304 generally includes data relating to each type of user of the VBT system 100. FIG. 5 is a block diagram showing the different types of user data 304 that may be stored by the VBT system 100. The user data 304 includes student data 502. The student data 502 may include data about each student 102 registered to utilize the VBT system 100. Examples of student data 502 include a student's name, an identification number for the student, the course(s) in which the student is enrolled, and data relating to the student's performance with respect to the enrolled course. Other data about the student may also be maintained and will be further discussed in connection with FIG. 6 below. The user data 304 may also include administrative data 504. The administrative data 504 typically includes data related to the over management of the VBT system 100. By way of example and not of limitation, the administrative data 504 may include data related to user licenses, user permissions, or some other data that is accessed and/or modified by the system administrator 106 via the administrator module 210.

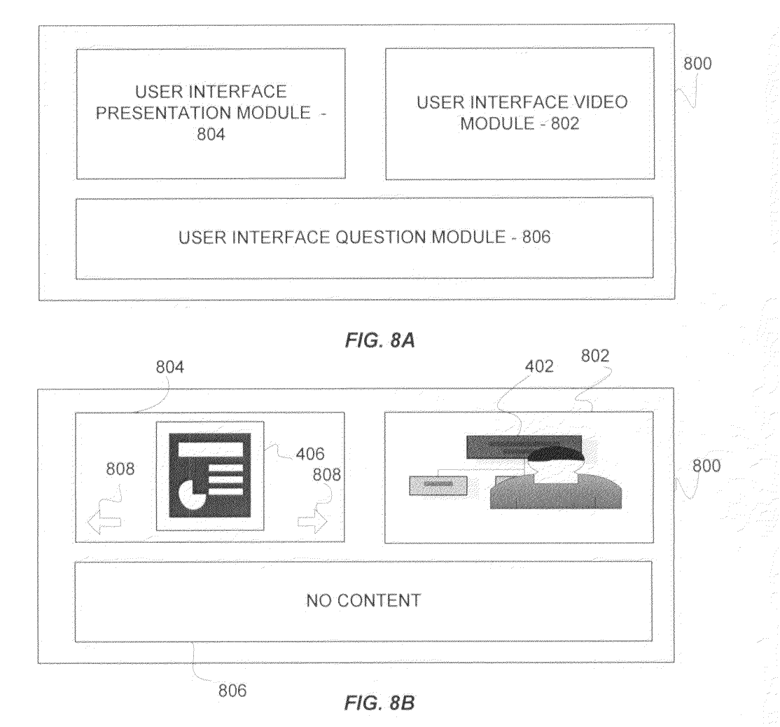

The user data 304 may also include pedagogical coordination data 506 and training coordination data 508. The pedagogical coordination data 506 typically includes data related to the pedagogical coordinators 104 and training coordinators 105 accessing the VBT system 100 via the pedagogical coordination module 208, and is discussed in additional detail below with reference to FIG. 7. The training coordination data 508 typically also includes data related to the training coordinators 105 and accessing the VBT system 100 via the training coordination module 210.

Referring now to FIG. 6, a more detailed view of the student data 502 is provided. As shown in the figure, the student data includes assigned courses 602. The assigned courses 602 include any and all courses 303 defined in the VBT system 100 to which a student 102 is assigned. The student 102 typically has permission to access the course content for any of the courses 303 associated with the student account. The student data 502 may also include group membership data 604. Students 102 may be placed into groups in order to more easily manage their access permissions. The administrator 106 may use the administrator module 210 to define groups and grant access to courses 303 based on group membership. Students 102 may be members of several groups.

The student data 502 for each student 102 may also include performance data 606. The performance data 606 tracks the student's progress and performance in both in-progress courses 303 and completed courses 303. The performance data 606 may track the performance of students 102 with respect courses 303 generally, and may also track the performance of students on specific lessons or intervals 404 contained within the courses 303. In addition, the student data 502 may include other data 608 such as contact information or some other data.

Referring now to FIG. 7, a block diagram showing a more detailed view of the pedagogical coordination data 506 is provided. As noted previously, the pedagogical coordination data typically includes data related to the pedagogical coordinators 104. As shown in FIG. 7, the pedagogical coordination data includes courses managed 702 by the pedagogical coordinators 104. Pedagogical coordinators 104 may manage several courses 303 on behalf an organization or company. The pedagogical coordination data 506 may further include groups 704 which are managed and/or maintained by the pedagogical coordinator 104. The managed groups 704 typically include those groups of users 102 affiliated with the same company or organization as the pedagogical coordinator 104.

Pedagogical coordinators 104 may also be assigned students 102 to manage individually. As a result, the pedagogical coordination data 506 may further include a list of students managed 706 by the pedagogical coordinator. Maintaining managed student 706 on a individual rather than a group basis allows the pedagogical coordinator more flexibility in managing associated courses 303 and students 102 in the VBT system 100.

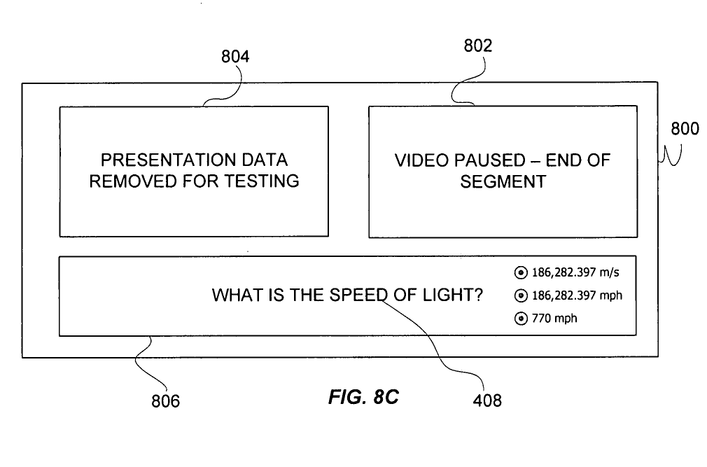

As discussed previously, in certain embodiments the VBT system 100 provides student 102 a multi-sensory learning experience by providing a integrated leaning environment within a single browser application. FIGS. 8A-8C are examples of a user interface 800 in various states of use having three inter-related viewing modules. With reference to FIG. 8A, the inter-related viewing modules include a user interface video module 802 in which course-related video data 402 is displayed to the user. The user interface video module 802 does not require the use of separate media player software such as Windows Media Player, Quicktime Player, or RealPlayer, but instead is provided through the use of technology provided by the web browser software, such as Java applets or AJAX, for example, embedded into the browser web page.

The user interface 800 also includes a user interface presentation module 804 which displays presentation data 406 to the user which is related to the video data 402. Although the presentation data 406 may be originally loaded into the system as a presentation file such as a Powerpoint file, for example, it may be converted by the VBT system 100 into a form more suitable for display within a browser application. As a result, the presentation data 406 may be provided as a graphics image such as a GIF, TIF or JPEG file.

The user interface 800 further includes a third module, the user interface question module 806, which displays questions to the student 102 at designated moments in time. These questions may be provided as text blocks with forms designed to capture answers from the students 102. In one embodiment, the question data 408 may be displayed as text, with an HTML form used to offer answer choices to the student and receive a student input selective of one of the answer choices.

Although the user interface 800 in FIG. 8A shows each of the sub-modules positioned in a specific location, one of skill in the art will appreciate that the modules may be positioned in various relative configurations, and that the configuration shown is merely exemplary in nature. Moreover, additional interface modules may also be included in the user interface 800 to display additional data to the student 102.

As discussed previously, in some embodiments the VBT system 100 operates to provide a course delivery environment which requires the student 102 to understand and retain viewed content before proceeding further into the course 303. FIGS. 8B and 8C provide an illustration of how the user interface 800 is configured to implement this type of learning environment. Referring now to FIG. 8B, the user interface 800 is shown while operating in a lecture/teaching mode. The user interface video module 802 is receiving and displaying video data 402 from the video serving module 202 of the VBT system 100. The video data 402 may be a particular segment 404 of the video data related to the course 303 being delivered to the student 102.

While the video data 402 is displayed, the user interface presentation module 804 provides presentation data 406 to the student much as a lecturer would provide a slide show during a live lecture. The presentation data typically includes slides related to the course lecture displayed in the video data 402. In some embodiments, the presentation data 404 may be tied to the video data 402 so that the user interface presentation module 804 displays slides in concert with the subject matter covered in the lecture. Alternatively, the student 102 may be given control over navigating the slide show. In one embodiment, the control may be provided via interface elements 808(a) and 808(b) which may be activated or actuated by the student 102 to move to a previous or subsequent slide. While in the lecture/teaching mode, the VBT system typically does not display content in the user interface question module 806. This portion of the user interface 800 may be left blank so as not to distract the student 102 from the course material the student is learning.

When the endpoint of the video interval 404 displayed in the user interface video module 802 is reached, the user interface 800 moves into the testing mode. The testing mode is generally for the purpose of providing a performance monitoring role that encourages the student 102 to pay attention to the course material delivered to the user interface 800 when it is in the lecture/teaching mode. FIG. 8C provides an example of how the user interface 800 environment may change in response to a shift from teaching/lecture mode to the testing mode. As shown in the figure, the video data 202 and the presentation data 204 are no longer displayed in the user interface 800. Instead, at the conclusion of the video interval, the user interface question module 806 is activated to deliver question data 408 in the form of questions and answer choices related to the previously viewed video data 402 and presentation data 404.

The questions displayed in the user interface question module 806 may be selected from a question bank that includes many questions related to each video interval 404. Multiple questions may be provided for each interval 404 so that if a student is required to repeat viewing a particular video interval 404, the student 102 cannot simply remember the correct answer from an already viewed question to advance to the next video segment. If the student selects the correct answer from the question data 408, the student 102 is permitted to proceed to the next video segment 404 and advance further into the course 303. When the student 102 makes an answer selection, this selection (whether correct or incorrect) is stored in the data storage 214 and may be used to create or compile course performance data 410 for the course 403 or student performance data 606 for the student 102.

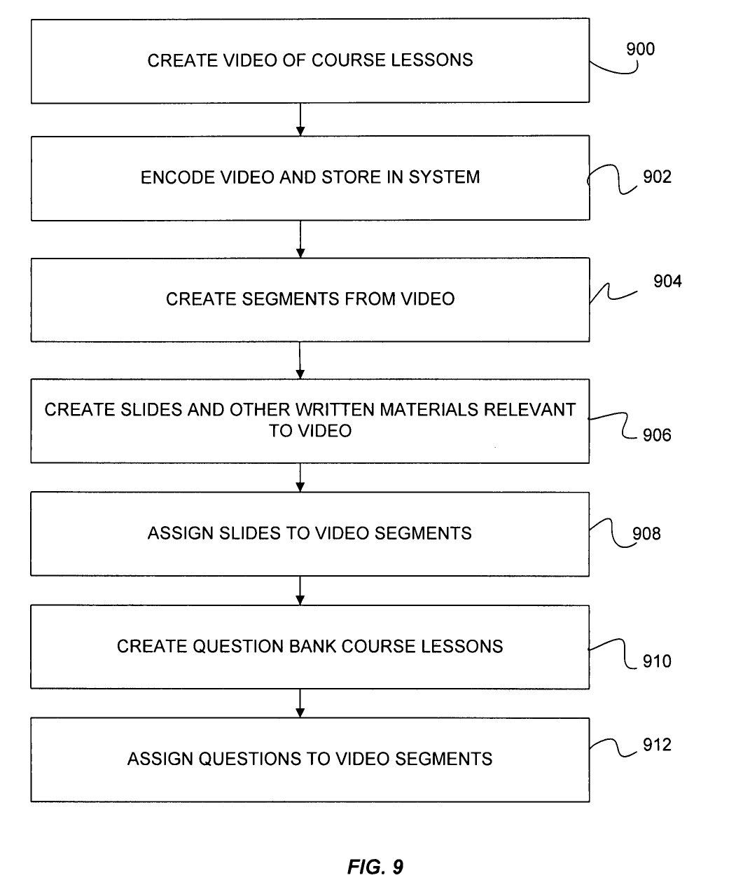

As noted previously, various aspects of the invention provide a platform from which a pedagogical coordinator 104 or some other content creator can efficiently and inexpensively create courses 303 which can be distributed to students 102 using the VBT system 100. FIG. 9 is a flow diagram of a process by which course data 302 may be created, uploaded, and stored in the VBT system 100.

The process begins at block 900 where a video is created of the course lessons. The video may be a standard video created using a traditional video taping device such as video camera. Once the video has been recorded of each lesson, the process moves to block 902, where the video is encoded/digitized and uploaded to the VBT system via the network 110. The video encoding may be performed by the pedagogical coordinator 104 using a video encoding software such as Adobe Premiere, for example, or by some other software offered by part of the pedagogical coordination module 208. Alternatively, the pedagogical coordinator 104 may send the video tape or DVD to the administrator 106 so that the administrator may encode the video and upload it to the VBT system 100.

Once the video has been digitized and uploaded to the VBT system 100 as video data 402, the process moves to block 904. At block 904, the digitized video 402 is divided into video segments 404. Standard video editing software, such as Adobe Premiere, for example, may be used to create the video segments 404. The pedagogical coordination module 208 may provide remote access to the video editing software which allows the pedagogical coordinator 104 to easily create the video segments. Alternatively, the administrator 106 may create the video segments 404 on behalf of the pedagogical coordinator 104. Once the video segments are created, the process moves to bock 906, where slides 406 and other written materials related to the video data 402 are created. Although the slide creation is shown in the process of FIG. 9 as occurring subsequent to the encoding and segmentation of video, a skilled artisan will appreciate that the slide creation may take place concurrently with, or prior to the creation and encoding of the video. Once the written materials have been created, the process moves to block 908, where the slides are assigned to video segments 404. Like before, this process may be performed by the pedagogical coordinator 104, or it may be performed by some other party such as the administrator 105 or training coordinator 106.

The process then moves to block 910 where the question bank questions and answers 408 for the course lessons are created. As discussed previously, the question data 408 typically includes questions related to the course material covered in each video segment 404. Typically, at least several questions are created for each segment 404 so as to allow the student 102 to receive a different question each time they are tested on the video segment 404. As with the other content, the question bank may be created by the pedagogical coordinator 104 utilizing the pedagogical coordination module 208. Once the questions are created and stored in data storage 214, the questions may then be assigned to video segments 404 at block 912. In some embodiments, a single question may be assigned to more than one video segment 404. This is especially useful where the subject matter covered in the lessons 303 of the course includes core and fundamental concepts that should be reinforced in the students learning.

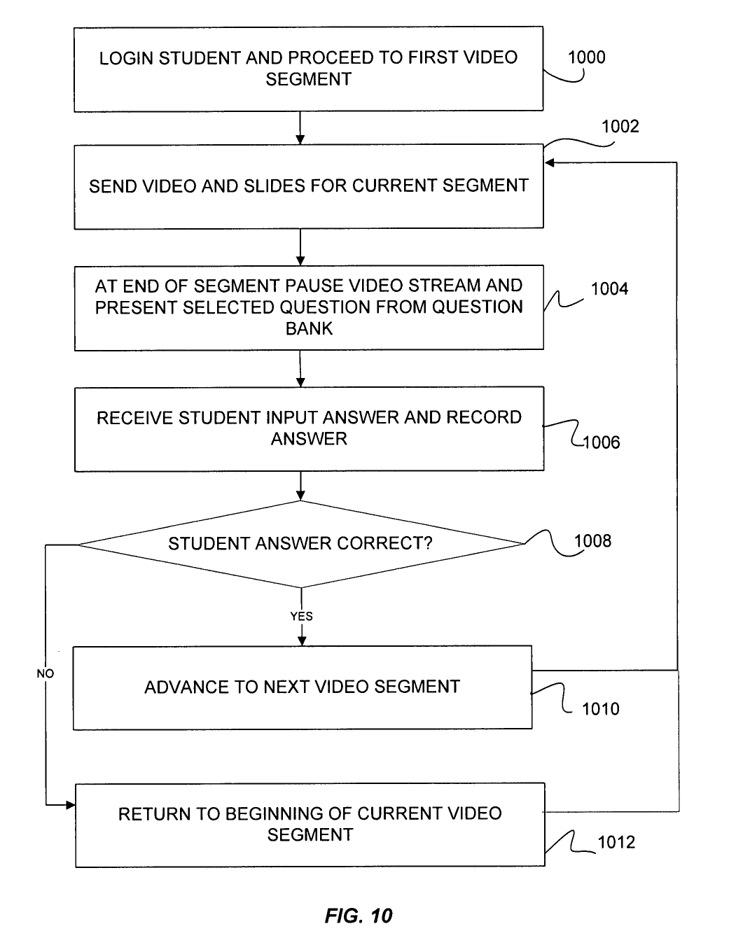

Once a course 303 and its associated lessons are created as described above, it is typically made accessible to the students 102 who are assigned to the course 303. FIG. 10 is a flow diagram illustrating how a student 102 may access the VBT system 100 over the network 110. The process begins at block 1000, where the student 102 submitted their login credentials to the system 100 and is authenticated to the system 100 if their credentials are sufficient. Once the student has successfully logged into the VBT system 100 and selected a course 303 to attend, the video serving module 202 and the presentation management module 204 begin to send video data 402 and slide data 406 to the student 102 via the network 110. The video and slides are then displayed in to the student 102 in the user interface video module 802 and presentation module 804, respectively.

As discussed above, the video data 402 is divided into intervals 404 which comprise segments of the video for a particular lesson. At the conclusion of the video segment displayed to the student 102, the VBT system pauses the video stream and presents a question selected from the question bank in the user interface question module 806 at block 1004. Next, at block 1006, the student selects or inputs an answer to the question and that data is returned to the VBT system 100. Once the student response to the question is received, the process moves to block 1008, where the VBT system compares the student answer to the correct answer as stored in question data 408. If the student's answer is correct, the video serving module 202 advances to the next video segment at block 1010 (at which point the next video segment becomes the current video segment) and returns to block 1002 where it begins streaming the video and slides for the newly selected current video segment. Returning to block 1008, if the student response is incorrect, the VBT system 100 returns to the beginning of the current video segment at block 1012. From there, the process moves back to block 1002 and repeats the interval to the student so that they may attempt to learn the material again.

It will be understood by those of skill in the art that numerous and various modifications can be made without departing from the spirit of the present invention. Therefore, it should be clearly understood that the forms of the invention are illustrative only and are not intended to limit the scope of the invention.

What is claimed is:

1. A method of providing video-based training to a computing device in a computer network, the method comprising:
(a) sending training data comprising a plurality of video segments and a plurality of questions related to the video segments over the computer network, the video segments being delivered in a video stream to the computing device;
(b) pausing the video stream;
(c) sending a selected one of the questions relevant to a first video segment of the training data displayed prior to pausing the video stream;
(d) receiving data indicative of a response to the question;
(e) determining if the received data includes a correct response; and
(f) if the received data does not include a correct response, resending the video stream from the beginning of the segment of the video training data displayed prior to pausing the video stream and replaying the segment of the video training data displayed prior to pausing the video stream.

2. The method of claim 1, further comprising:
(g) if the received data includes a correct response, resuming the video stream;
and sending a second video segment in the video stream.

3. The method of claim 2, further comprising repeating (b), (c), (d), (e), (f), and (g) for each delivered segment of video data.

4. The method of claim 3, further comprising:
storing each received response in a database; and
generating performance data based on the stored responses.

5. The method of claim 2, wherein the video training data comprises a lecture recorded on video.

6. The method of claim 5, further comprising a video playing module comprising a Java applet running within a web browser application.

7. The method of claim 3, wherein the each question is one of a plurality of questions related to one of the video segments.

8. The method of claim 7, wherein if the video stream returns to the beginning of a segment, the sent question is selected to be different from any previously displayed questions.

9. The method of claim 8, wherein the video stream for each segment is resent until the response to the question is a correct response.

10. The method of claim 3, wherein the training data further comprises one or more of electronic slides, computer animation, and simulation data for display on the client computer.

11. A system for providing video-based online training to a student, the system comprising:
a video serving module configured to access stored prerecorded video data having educational content, the prerecorded video data having a plurality of video segments, the video serving module being further configured to send the prerecorded video data to a computing device causing the computing device to play one of the segments of the video content in a video portion of a video module; and
a monitoring module configured to access a plurality of questions, each of the questions being related to one or more of the video segments, the monitoring module being further configured to pause the sending of video content at the end of one or more of the segments, and to send a question related to the video content requiring a response,
wherein if the response is not a correct response to the displayed question, the video serving module returns to the beginning of the segment and resends the video content in the segment to the computing device.

12. The system of claim 11, further comprising a slide distribution module configured to store content related to the prerecorded video and to send the content to the computing device for concurrent display in a slide show portion of a lesson page; and:

13. The system of claim 11, wherein if the response is a correct response, the video serving module sends prerecorded video data to the client computer causing the client computer to play another one of the video segments to the student.

14. The method of claim 11, wherein the video serving module returns to the beginning of the segment and resends the video content in the segment until the response to the question is a correct response.

15. The system of claim 13, wherein at the conclusion of each segment, the monitoring module displays a question from a list of questions related to the video content of that segment.

16. The system of claim 14, wherein the monitoring module is further configured to store each received response in a database and to generate performance data for the student based on the stored responses.

17. The system of claim 11, wherein the prerecorded video data comprises a lecture recorded on video.

18. The system of claim 11, wherein the lesson page on the client computer comprises at least one Java applet running within a web browser application, the at least one Java applet being configured to play video content and being further configured to maintain a session connection with the video serving module.

19. The system of claim 11, wherein the prerecorded video data, the content related to the video content data, and the plurality of questions comprise an online course.

20. The system of claim 19, wherein the system is further configured to store a plurality of the online courses.

21. The system of claim 20, further comprising a pedagogical coordination module, the pedagogical coordination module being configured to:
provide an interface for assigning the student to one or more of the plurality of online courses;
monitor the progress of the student by accessing performance data related to the student; and
adjust the level of training for the student based the performance data related to the student.

22. A computer-readable medium for generating a user interface for a browser software in a computer, the computer-readable medium including computer-executable instructions which, when executed send data to the browser causing it to create a user interface in a browser window, wherein the user interface comprises:
a video module configured to display streaming video in a video segment; and
a question module configured to display questions related to the video segment,
wherein the video module comprises a playerless video element configured to receive the video data through a socket connection.

23. The computer-readable medium of claim 22, wherein the playerless video element comprises a Java applet running within the browser interface.

24. The computer-readable medium of claim 22, further comprising a presentation module configured to display presentation data related to the streaming video, wherein the presentation module comprises an animated graphics image and one or more interface elements which, when activated, cause the graphic image to change its display.
